(19) United States
(12) Patent Application Publication
(10) Pub. No.: US 2009/0002627 A1
(43) Pub. Date: Jan. 1, 2009

(54) OPTICAL ELEMENTS HAVING VARIABLE POWER PRISMS

(75) Inventor: Milton KATZ, New York, NY (US)

Correspondence Address: HESLIN ROTHENBERG FARLEY & MESITI PC, 5 COLUMBIA CIRCLE, ALBANY, NY, 12203, US

(73) Assignee: The Research Foundation of State University of New York, Albany, NY (US)

(21) Appl. No.: 12/163,637

(22) Filed: Jun. 27, 2008

Related U.S. Application Data
(60) Provisional application No. 60/946,833, filed on Jun. 28, 2007.

(51) Int. Cl. G02C 7/14; G02B 3/08; G02B 3/10; G02C 7/06

(52) U.S. Cl. 351/170; 359/742; 359/654

(57) ABSTRACT

Optical elements having a plurality of integral prism facets having varying prismatic power are provided. These optical elements address the disadvantages of conventional therapeutic optical prisms by addressing the undesirable variation in prismatic effect that results when conventional prisms are combined with optical lenses in binocular vision. Specifically, the present invention can equalize differential prismatic effects of right and left eye lenses over their entire aperture. The optical elements may include a plurality of prism facets having base-down and base-up prismatic power. The elements may include individual elements having variable prismatic elements, individual elements combining both conventional prisms and variable prism, or separate elements having conventional prisms and variable prism. The plurality of integral facets or a substantially continuous smooth surface may be provided, for, example, a cylindrical surface having a circular or non-circular profile. Methods of correcting binocular vision are also disclosed.

### CROSS-REFERENCE TO RELATED APPLICATION

This application claims priority from pending U.S. Provisional Patent Application 60/946,833, filed on Jun. 28, 2007, the disclosure of which is incorporated by reference herein in its entirety.

### BACKGROUND OF THE INVENTION

1. Field of the Invention

The present invention relates to corrective optical prismatic devices, and more particularly, to corrective optical prismatic devices employing varying prismatic effects to correct the undesirable variation in prismatic effect of conventional optical prismatic devices.

2. Description of Related Art

Clear single binocular vision requires the eyes to accommodate and converge on the object of regard. Among the conditions that interfere with fusional eye movements are strabismus, heterophorias, and heterotropias. Patients are most sensitive to vertical imbalances. These imbalances may be caused by the vertical component of strabismus, or anatomic factors. Vertical imbalances also are induced by differential prismatic effects of anisometropic lens corrections by excursions downward of the lines of sight of the eyes from the optical centers. This may result in diplopia, asthenopia, dizziness, and difficulty reading.

Ophthalmic refractive and Fresnel prisms are commonly used in vision training and to correct binocular vision problems. These prisms have a uniform power specified in prism diopters, which is a deviation in centimeters at a distance of one meter. When combined with a lens, to correct binocular vision problems such as diplopia, strabismus, etc., as is common in optometric practice, the specified prism power is typically limited to a line-of-sight through the optical center of the lens. As the line of sight moves off-axis, the prismatic effect of the lens will alter the prism power of the combination. Consequently, the combination of the prism and lens may fail to provide the prescribed therapeutic prismatic correction throughout the range of mobility of the eyes.

Adverse prismatic effects may be manifested, for example, when an anisometropic patient with distance spectacles looks down through the lenses to read. Typically the lines of sight will intersect the lenses at about 1.0 centimeter (c=1) below the optical centers. The difference in dioptric powers (ΔF) between the two lenses will cause a difference in prismatic effects (PE), according to Prentice's Rule, of PE=cΔF. As a result, the eyes incur a hyperphoria at the reading level. Hyperphorias greater than about 1.5 prism diopters can have adverse effects on binocular vision. According to Prentice's Rule, if c=1 cm, the maximum allowable anisometropia to not induce a hyperphopia greater than 1.5 prism diopters at the reading level is 1.00 D.

Prism therapy is used extensively in vision training to treat patients with binocular vision conditions, such as, eyestrain, dizziness, and double vision, and to correct strabismus, and other vision problems. Existing prisms are characterized by a fixed prism power (in prism diopters) across their entire aperture. When such fixed power prisms are used in combination with a patient's lens prescription, the prescribed prism power is limited to a line of sight through the optical center of the lens. The effective prism power of the prism and lens combination varies as the eye makes excursions from the optical center of the lens due to the prismatic effects of the lens.

As indicated by Prentice's Rule, the prismatic effect of the lens varies linearly with the distance from the optical center of the lens. In anisometropic corrections, when a prism is provided, the typical varying prismatic effect of the prescribed lens is compounded by the prescribed prism power. Consequently, it is desirable to eliminate the differential prismatic effects due to anisometropia and to provide the correct amount of prescribed prism across the entire aperture of the lenses. Aspects of the present invention address this disadvantage of the prior art.

### SUMMARY OF THE INVENTION

Aspects of the present invention can equalize differential prismatic effects of right and left eye lenses over their entire aperture in aniso- and anti-metropia. In addition, aspects of the invention can provide constant prescribed therapeutic prism power across the lens aperture by offsetting the prismatic effect of a lens in the absence of anisometropia. Moreover, aspects of the invention can provide a variation in prism power for vision training in strabismus, head trauma, etc. conditions.

Aspects of the present invention address the above limitations of prior art prisms and prior art prism and lens combinations. According to aspects of the invention, a variable power or progressive power Fresnel prism is provided. One aspect of the invention maintains a substantially constant prism correction for binocular vision conditions, as such, diplopia and strabismus. Aspects of the invention are intended for correction of vision imbalance and in use in vision training and therapy. In one aspect, a prism is provided having a prism power that varies across its aperture to offset the prismatic effect of the lens. According to aspects of the invention, the variation in prismatic power of the present invention can provide an effective correction to the differential prismatic effects of the two lenses that occur with anisometric lens corrections when the eyes turn. By supplementing or replacing a conventional refractive or Fresnel prism with an aspect of the invention, when prisms are prescribed for therapeutic purposes, the desired prism power can be provided, for example, across the entire aperture of the lens and prism combination.

One aspect of the invention is an optical element or device comprising a plurality of integral prisms or facets having varying prismatic power. In one aspect, the plurality of prisms comprises a first plurality of prisms having a base-down prismatic-power and a second pluralitye of prisms having a base-up prismatic power. For example, in one aspect, the first plurality of base-down prism facets may be distributed in a portion of the element above the second plurality of base-up prisms. In another aspect, the first plurality of base-down prism facets may be distributed in a portion of the element below the second plurality of base-up prisms. In a further aspect, the plurality of facets may be provided by an optic having a substantially discontinuous or continuous surface, for, example, a surface approaching the contour or a cylindrical surface, a spherical surface, or an aspherical surface.

In another aspect of the invention, a method of correcting or treating binocular vision problems due to anisometropia is provided. The method may include or comprise neutralizing differential prismatic effects upon light rays passing through the right and left ophthalmic lenses. The method may include providing a right lens and a left lens having differential prismatic effect upon light rays passing through the lenses; and positioning one of the optical elements recited above to modify at least some of the differential prismatic effects of one of the lenses on the light rays. In one aspect, providing the lenses may comprise providing positive lenses or negative lenses. The lenses may spherical, aspherical, or sphero-cylindrical in shape.

In another aspect of the invention, a method for correcting fixed power therapeutic prisms prescribed for treating binocular vision problems and which are altered in power across their apertures by the prismatic effects of lenses is provided. The method may employ a variable power prism adapted to neutralize the prismatic effects of the lenses and supply a fixed therapeutic prism power across the full aperture.

Another aspect is an optical element comprising a plurality of integral prism facets having varying prismatic effect. In one aspect, the plurality of facets comprises a first plurality of facets having a base-down prismatic effect and a second plurality of facets having a base-up prismatic effect. In another aspect, the first plurality of prism facets is positioned above an optical center of the element and the second plurality of prism facets is positioned below the optical center of the element or the first plurality of prism facets is positioned below an optical center of the element and the second plurality of prism facets is positioned above the optical center of the element. In one aspect, the absolute value of the prismatic effect of the first plurality of prism facets and the second plurality of prism facets increases with a distance from an optical center of the device. In a further aspect, the optical element further comprises a third plurality of prism facets having a substantially constant prismatic effect.

Another aspect of the invention is an optical arrangement comprising a lens having a prismatic effect upon light rays passing through the lens; and the optical element described above; wherein the varying prismatic effect of the optical element modifies at least some of the prismatic effect of the lens on the light rays. In one aspect, the prismatic effect of the lens comprises a prismatic effect that varies across the lens. In another aspect, the lens comprises one of a positive ophthalmic lens and a negative ophthalmic lens.

Another aspect of the invention is an optical element comprising a substantially continuous, smooth surface providing varying prismatic power. In one aspect, the substantially continuous, smooth surface comprises one of a circular profile and a non-circular profile, for example, a conic profile, for instance, a elliptical, parabolic, or hyperbolic profile.

A further aspect of the invention is a method of correcting binocular vision comprising providing a right lens and a left lens having differential prismatic effect upon light rays passing through the lenses; and positioning one of the optical elements described above to modify at least some of the differential prismatic effect of the lenses.

These and other aspects, features, and advantages of this invention will become apparent from the following detailed description of the various aspects of the invention taken in conjunction with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIGS. 1A and 1B are schematic illustrations of prisms, prism conventions, and prism nomenclature referred to in the descriptions of aspects of the invention.

FIG. 2 schematically illustrates the typical differential prismatic effect of prescription lenses that characterizes the prior art.

FIGS. 3A through 3E are schematic illustrations showing the beneficial effects of aspects of the invention.

FIGS. 4A and 4B are schematic illustrations of aspects of the invention.

FIGS. 5, 6, and 7 are plots of the improvements in differential prismatic effect provided by aspects of the invention.

FIG. 8 is a perspective view of an optic according to another aspect of the invention.

FIG. 9 is a front elevation view of the optic shown in FIG. 8.

FIG. 10 is a side elevation view of the optic shown in FIG. 8.

FIG. 11 is a set of curves illustrating the prismatic effect of one aspect of the invention.

FIG. 12 is another set of curves illustrating the prismatic effect of one aspect of the invention.

FIG. 13 is a perspective view of an arrangement of a prism optic and a lens according to an aspect of the invention

### DETAILED DESCRIPTION

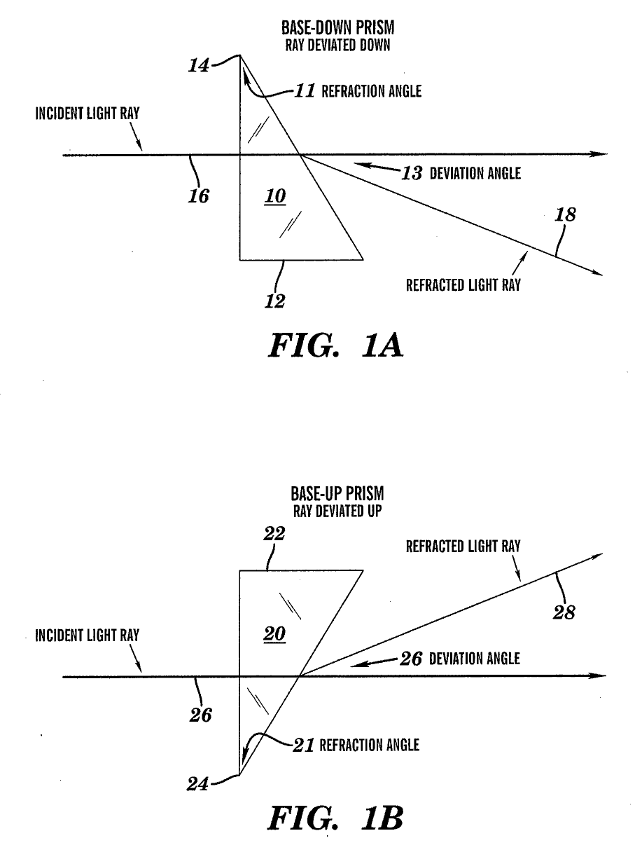

FIGS. 1A and 1B are schematic illustrations of prisms and prism conventions and nomenclature referred to in the descriptions of aspects of the invention. FIG. 1A illustrates a “base-down” prism 10. According to the conventional art, base-down prism 10 is oriented whereby its base 12 is directed downward and its apex 14 is directed upward. As is known in the art, an incident light ray 16 entering prism 10 is refracted downward, in a direction generally toward base 12, and exits prism 10 as refracted light ray 18. According to convention, the refracting angle 11 of prism 10 is the angle between the vertical face and the inclined face of prism 10, as shown, and the deviation angle 13 is the angle obtained by rotating the direction of incident ray 16 into the direction of the refracted ray 18 in a clockwise rotation. According to convention, such a base-down prism, which deviates the path of the light ray downward, is characterized as providing a negative deviation or negative prismatic power. The prismatic power of prism 10 is constant for parallel incident light rays across the entire width or aperture of prism 10.

FIG. 1B illustrates a “base-up” prism 20. According to the conventional art, base-up prism 20 is oriented whereby its base 22 is directed upward and its apex 24 is directed downward. As is known in the art, an incident light ray 26 entering prism 20 is refracted upward, in a direction generally toward base 22, and exits prism 20 as refracted light ray 28. The refracting angle 21 of prism 20 is the angle between the vertical face and the inclined face of prism 20. The deviation angle 23 of prism 20 is the angle obtained by rotating the direction of incident ray 26 into the direction of refracted ray 28 in a counter-clockwise rotation. According to convention, such a base-up prism, which deviates the path of the light ray upward, is characterized as providing a positive deviation or positive prismatic power. Again, the prismatic power of prism 20 is constant for parallel incident light rays across the entire width or aperture of prism 20.

Also, according to convention, a “plus” lens has base-down prismatic power across the portion of its aperture above the optical center, and a base-up prismatic power across the portion of its aperture below the optical center. Conversely, according to convention, a “minus” lens has base-up prismatic power across the portion of its aperture above the optical center, and a base-down prismatic power across the portion of its aperture below the optical center

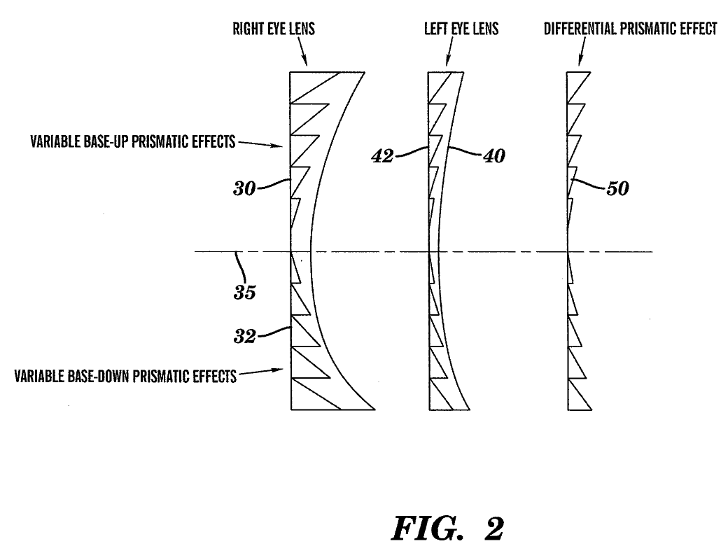

FIG. 2 schematically illustrates the typical differential prismatic effect of prescription lenses that characterizes the prior art. Specifically, FIG. 2 is a schematic illustration of how the prismatic effects of a set of anisometropic prescription lenses result in differential prismatic effects. FIG. 2 includes a first concave lens 30, representing the prescription lens for the right eye of the user, and a second lens 40, representing the prescription lens of the left eye of the user, the prescription for which may be the same or different from the prescription of the right eye lens 30. The shaded patterns 32 for lens 30 and 42 for lens 40, respectively, represent the variation in prism powers across the apertures of, for example, a strong negative right eye lens 30 and a relatively weaker negative left eye lens 40. The resultant differential prismatic effect due to the anisometropic prescription is represented by the varying prismatic powers 50. As clearly illustrated in the example shown in FIG. 2, the prismatic effect may increase linearly with the distance from the optical center line 35 of the lenses 30 and 40. According to aspects of the invention, this undesirable, varying prismatic effect represented by differential prismatic effect 50 can be minimized or eliminated by providing a variable power prismatic element which at least partially, typically substantially totally, counteracts the undesirable prismatic effects of lenses 30 and 40. In other words, aspects of the invention may minimize or eliminate the anisometropic-induced differential prismatic effects between the two lenses of an eyeglass prescription.

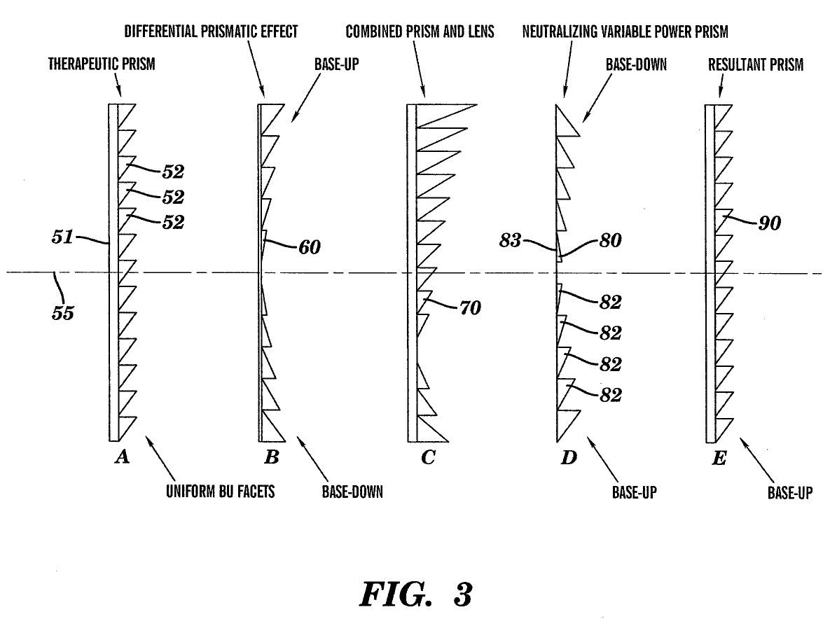

FIGS. 3A through 3E are schematic illustrations showing the beneficial effects of aspects of the invention. FIGS. 3A through 3E are not drawn to scale so that aspects of the invention may be more clearly illustrated. FIG. 3A is a schematic illustration of a constant-power therapeutic prismatic element 51 according to the prior art. As shown, prismatic element 51 typically includes a plurality of individual facets or prisms 52, all having substantially the same prismatic power, in the example shown, uniform, positive, base-up (BU) facets 52. Such a prism 51 may typically be prescribed to correct binocular vision conditions, as such, diplopia and strabismus.

FIG. 3B is a schematic illustration of a typical differential prismatic effect 60 due to one or more conventional lenses, such as, lens 30 and/or 40 shown in FIG. 2, for example, due to anisometropia. FIG. 3C is a schematic illustration of the combined prismatic effects of the therapeutic prism 50 and the differential prismatic effect 60 of a prescription lens. As shown in FIG. 3C, the combined differential prismatic effects represented by prisms 70 alter the desired constant power of therapeutic prism 51.

FIG. 3D is a schematic illustration of one aspect of the invention that overcomes the undesirable varying prismatic effect shown in FIG. 3C. FIG. 3D is a schematic illustration of a variable prism 80 having facets 82 that can neutralize at least some of the differential prismatic effect illustrated in FIG. 3C, for example, due to anisometropia. FIG. 3E is a schematic illustration of one resultant prismatic effect that can be achieved according to aspects of the invention. As shown, by providing varying prism 80 having facets 82 of varying prismatic power, the resulting prismatic effect represented by prisms or facets 90 may be provided, for example, providing the desired therapeutic prismatic effect shown in FIG. 3A, while not distorting the effect of the desired corrective lens shown in, for example, FIG. 3B.

Returning to FIG. 3D, this figure presents a schematic illustration of a variable power prismatic element 80 according to one aspect of the invention. Variable prismatic element 80 includes a plurality of facets or prisms 82 that are adapted to vary in power specifically to restore a constant therapeutic prism power, for example, a plurality of base-down prism facets above the optic centerline 55, and a plurality of base up prism facets below the optic centerline 55. Prisms 82 may typically be mounted on an optical substrate 83, for example, an optical glass or transparent plastic substrate. In one aspect, prism element 80 may also comprise a plurality of base-up prism facets 82 above the optic centerline and a plurality of base down prism facets 82 below the optic centerline. In contrast to therapeutic prismatic element 51 shown in FIG. 3A, when prismatic element 80 is combined with lens 60, prismatic element 80 at least partially counteracts, but may substantially totally counteract, the differential prismatic effect of lens 60 to provide the desired prismatic power, for example, the prismatic power illustrated by prism 51. In other words, in one aspect, the combination of prism 80 and lens 60 provides the prismatic effect of prism 51 with the desired prismatic effect correction of lens 60.

Variable power prism element or optic 80 in FIG. 3D, as well as any prism disclosed herein, may be made from transparent plastic, such as, a polycarbonate, a polystyrene, or a polymethyl methacrylate [PMMA] (for example, a PMMA sold under the tradename Plexiglas); or glass, for example, optical quality glass. Prismatic element 80, and any other aspects of the invention disclosed herein, may typically correspond in size and shape to the lenses in a spectacle frame, for example, have a vertical dimension or diameter of between about 20 mm and about 60 mm, for example, about 50 mm, and a thickness of between about 0.5 and about 10 mm, for example, about 2 mm.

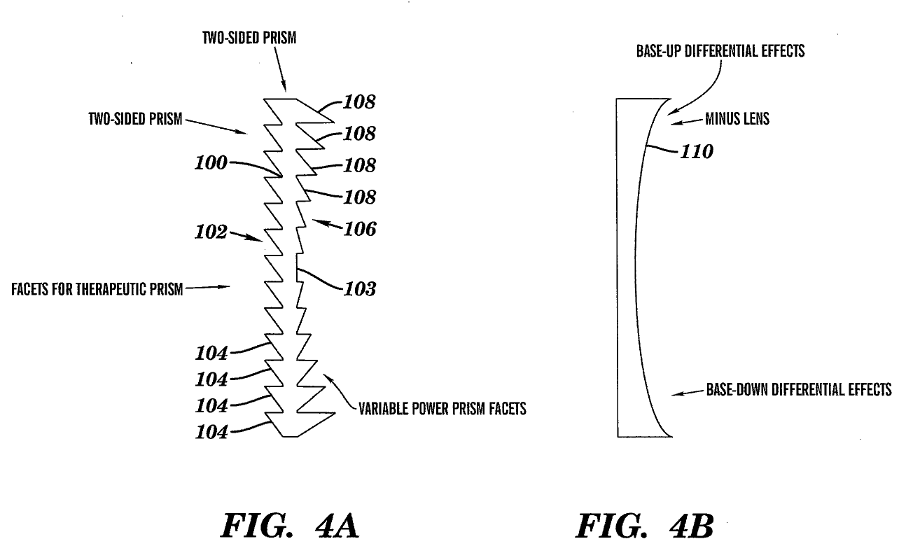

The facets shown in FIGS. 3 and 4A, for example, facet 82 or 108, may have heights or widths that vary broadly according to aspects of the invention. For example, height of the facets may vary from as small as 1-100 nanometers (nm) to 1-100 micrometers (um) to as large as 10 to 1000 millimeters (mm), depending upon the requirements of the application. However, according to one aspect of the invention, the length, width, and depth of facets may vary from about 0.5 to 10 mm, for example, from about 1 mm to about 2 mm.

FIGS. 4A and 4B are schematic illustrations of another aspect of the invention. FIG. 4A is a schematic illustration of a two-sided variable power prismatic element 100 according to one aspect of the invention. FIG. 4B is a schematic illustration of a negative (minus) lens 110 that can be combined with the prismatic element 100 shown in FIG. 4A (or with prismatic element or optic 80 shown in FIG. 3D) according to one aspect of the invention. According to this aspect of the invention, prismatic element 100 includes a first side 102 having a first plurality of substantially constant power prism facets 104 and a second side 106 having a second plurality of varying power prism facets 108. Typically, prism facets 104 and 108 may be mounted to a substrate 103, for example, a substantially optical quality glass substrate. In one aspect of the invention, prisms 104 provide a first, substantially constant, prismatic effect, and prisms 108 provide a second variable prismatic effect to counteract the prismatic effect of lens 110 shown in FIG. 4B. In another aspect of the invention, prisms 104 may provide a first, variable prismatic effect, and prisms 108 may provide a second substantially constant prismatic effect. In one aspect, both prisms 104 and 108 may vary in prismatic power. Lens 110, and any lens that may be used with any aspects of the invention disclosed herein, may be a positive lens or a negative lens and may be spherical, aspherical, or sphero-cylindrical in shape. In another aspect, the relatively constant power prisms 104 may be provided by a second prism element (not shown), that is, separate from prism element or optic 100.

In another aspect of the invention, separate prisms may be provided. For example, a therapeutically prescribed prism having, for example, facets of constant power (such as, facets 104 in FIG. 4A), may be provided on one surface of a first substrate and a variable power prism having facets of variable power, such as, facets 108 in FIG. 4A, may be provided on a second, separate substrate.

### Analysis and Computations

### EXAMPLE 1

As an example of the details and benefits of aspects of the invention. The following analysis and calculations are provided. The calculation of vertical imbalances caused by differential prismatic effects due to anisometropia when eyes turn downward to read can be calculated based upon the following assumptions:
Given: Spherical lenses.
   Right eye distance lens Rx. F=−4.00 diopters
   Left eye distance lens Rx F=−1.00 diopters
   Lines of sight intersect lenses 1.0 cm below the optical centers of the lenses.
      Note that in the following calculations, the above parameters this will be converted to a decentration (d) of the lens, therefore, d=+1.0 cm. In other words, decentering a negative lens up, introduces a base-down effect that is equivalent in prism diopters to turning the eyes downward.

According to Prentice's rule, the prismatic effect, Pe^{Δ}, of a lens is given by

Pe^{Δ}=d×F

where d=distance from optical center (in cm), provided above, and F=dioptric power of the lens, as also given above. Solving this equation for both eyes yields:

Right eye prismatic effect=Pe^{Δ}=1.0×−4.00=−4.0^{Δ} base-down

Left eye prismatic effect=Pe^{Δ}=1.0×−1.00=−1.0^{Δ} base-down

Therefore, the differential prismatic effect (ΔPe^{Δ}) at this reading level is (−1.0−(−4.0)=)3.0^{Δ} base-down for the right eye. A 3.0^{Δ} base-up prism at this level will equalize the prismatic effects for the two eyes.

The differential prismatic effect can be found directly with the anisometropic difference in lens powers (ΔF) between the right and left eyes. Thus,

ΔPe^{Δ}=d×ΔF=1×(−4.00+1.00)=−3.0^{Δ} base-down, right eye.

Again, it should be noted that a vertical imbalance greater than about 1.5^{Δ} can adversely affect binocular vision.

Table A below summarizes the binocular variation in prismatic effects from +2.0 cm to −2 cm in steps of 1.0 cm; the differential prismatic effects between the two eyes, and the variable power prism (VPP) for the right eye to equalize the prismatic effects.

TABLE A

| d (cm) | Pe^{Δ} right eye(RE) | Pe^{Δ} left eye (LE) | ΔPe^{Δ} (RE − LE) | VPP right eye |
|---|---|---|---|---|
| 2.0 | −8.0^{Δ} base-down | −2.0^{Δ} base-down | −6.0^{Δ} base-down | +6.0^{Δ} base-up |
| 1.0 | −4.0^{Δ} base-down | −1.0^{Δ} base-down | −3.0^{Δ} base-down | +3.0^{Δ} base-up |
| 0.0 | 0.0 | 0.0 | 0.0 | 0.0 |
| −1.0 | +4.0^{Δ} base-up | +1.0^{Δ} base-up | +3.0^{Δ} base-up | −3.0^{Δ} base-down |
| −2.0 | +8.0^{Δ} base-up | +2.0^{Δ} base-up | +6.0^{Δ} base-up | −6.0^{Δ} base-down |

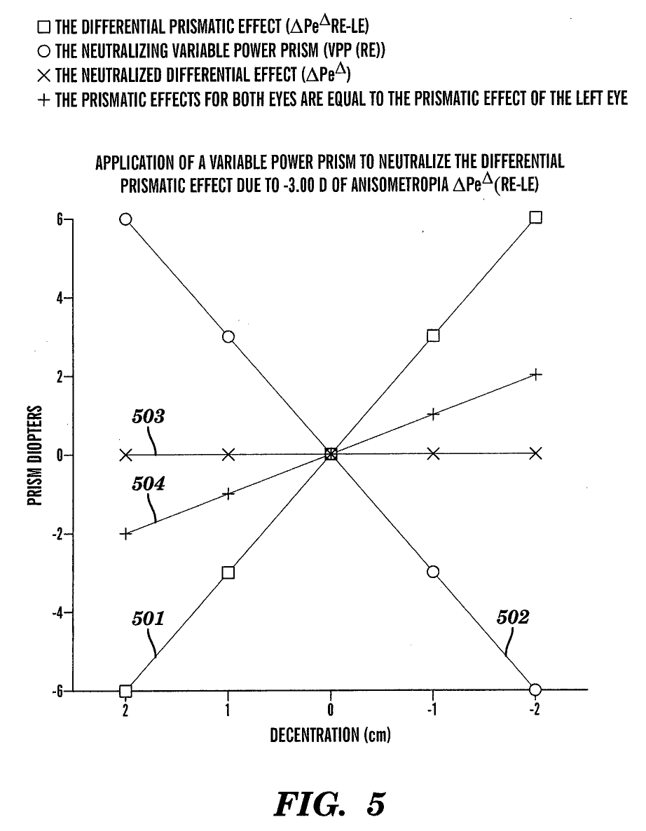

FIG. 5 is an example of a representative plot of the effect of one aspect of the invention. FIG. 5 represents the data presented in Table A and illustrates the neutralizing optical effect of an aspect of the invention when applied to a right eye (RE) and a left eye (LE) lens prescription that provides a −3.00 diopter [D] difference in anisometropia (ΔPe^{Δ}) between the right eye and the left eye, that is, ΔPe^{Δ}(RE-LE). The ordinate in FIG. 5 is in prism diopters and the abscissa in FIG. 5 is the centimeters (cm) of decentration. Decentration is the distance from the optical centerline of the lenses, that is, a decentration of 0 represents the optical centerline. Line 501 (identified with ▪) represents the differential prismatic effect [ΔPe^{Δ}(RE-LE)] of a prescription lens set. Line 502 (•) represents the variable power prism power according to aspects of the invention applied to the right eye (RE) that can neutralize the undesirable differential prismatic effect of the prescription lenses. Line 503 [symbol] represents the resulting neutralized differential effect (ΔPe^{Δ}), and line 504 [symbol] represents the resulting prismatic effects for both eyes by applying aspects of the invention, which in this example, is equal to the prismatic effect of the left eye (LE). Illustrates the differential prismatic effect (ΔPe^{Δ}) and its neutralization by variable power Fresnel prism (VPP right eye) given the RX: RE −4.00 D, LE −1.00 D. The anisometropia=−3.00 D. # Differential prismatic effect (ΔPe^{Δ}) _ Variable power neutralizing Fresnel prism power (VPP right eye), X Neutralized differential prismatic effect (ΔPe^{Δ}), and _ Prismatic effect for both eyes, (The prismatic effect for each eye is identical and equal to the Pe^{Δ} left eye.).

### EXAMPLE 2

In this example, the anisometric patient in Example 1 develops a strabismus that requires a +10^{Δ} base-up prism in front of the right eye to restore single binocular vision. In this case it is necessary to correct the anisometropic, Pe, as in Example 1 and to add the +10^{Δ} base up (BU) to design a combined variable power prism (VPP) as shown in the last column of Table B below.

TABLE B

| d (cm) | ΔPe^{Δ} (RE − LE) | VPP (RE) | Therapeutic | Total VPP (RE) |
|---|---|---|---|---|
| 2.0 | −6.0^{Δ} BD | +6.0^{Δ} BU | +10.0^{Δ} BU | +16.0^{Δ} BU |
| 1.0 | −3.0^{Δ} BD | +3.0^{Δ} BU | +10.0^{Δ} BU | +13.0^{Δ} BU |
| 0.0 | 0.0 | 0.0 | +10.0^{Δ} BU | +10.0^{Δ} BU |
| −1.0 | +3.0^{Δ} BU | −3.0^{Δ} BD | +10.0^{Δ} BU | +7.0^{Δ} BU |
| −2.0 | +6.0^{Δ} BU | −6.0^{Δ} BD | +10.0^{Δ} BU | +4.0^{Δ} BU |

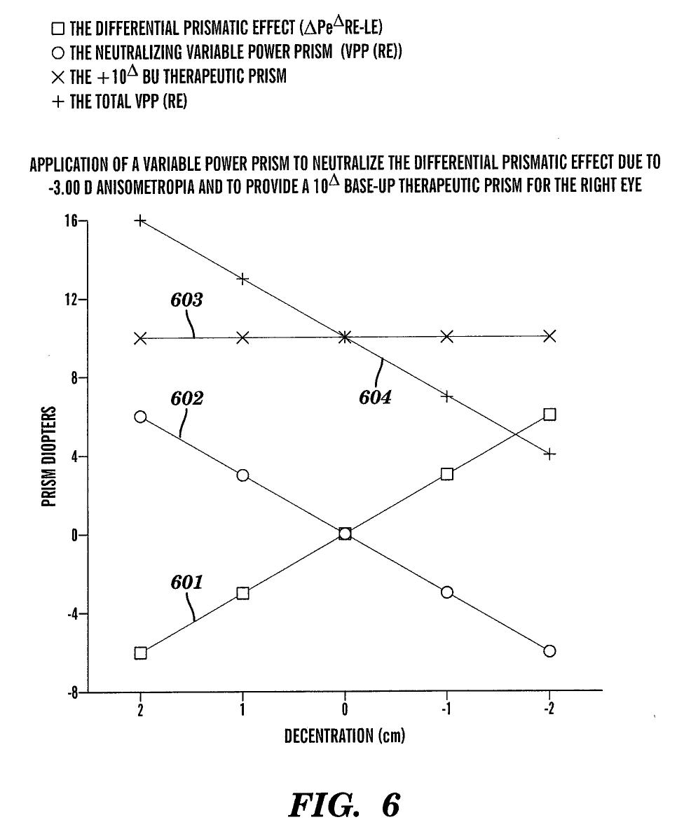

This example illustrates the use of a variable power prism to correct for the differential prismatic effects caused by the anisometropia and incorporate a therapeutic prism of 10^{Δ} base-up for the right eye. FIG. 6 is another example of a representative plot, similar to the plot in FIG. 5, of the effect of one aspect of the invention. FIG. 6 summarizes the data in Table B and represents the neutralizing optical effect of an aspect of the invention when applied to a right eye and a left eye lens prescription that provides a −3.00 D difference in anisometropia and also provides a +10 D base-up therapeutic prism for the right eye (RE). Line 601 (identified with ▪) represents the differential prismatic effect [ΔPe^{Δ}(RE-LE)] of a prescription lens set. Line 602 (•) represents the variable power prism power according to aspects of the invention applied to the right eye (RE) that can neutralize the undesirable differential prismatic effect of the prescription lenses. Line 603 [symbol] represents the +10 D therapeutic prism, and line 604 [symbol] represents the resulting prismatic effects for both eyes by applying aspects of the invention.

According to aspects of the invention, the total variable power prism (VPP) for the right eye (RE) may be prescribed in three forms:
1) a 10^{Δ} base-up therapeutic prism and the VPP (RE) Fresnel prism on separate substrates;
2) a 10^{Δ} base-up therapeutic Fresnel prism and the VPP (RE) Fresnel prism, molded for example, on opposite faces of a single substrate; and
3) the combined variable power prism (Total VPP (RE)) molded on one face of a substrate.

### EXAMPLE 3

In this example, a calculation of vertical imbalances caused by differential prismatic effects due to anisometropia when eyes turn downward to read is provided. Specifically, the patient in Example 2 also has an astigmatism and requires 10^{Δ} base-up for the right eye. In this calculation, the following assumptions are made:
Given: Spherical lenses.
Right eye distance lens Rx. F=−4.00 Dₛₚₕ/−3.00 D_{cyl} axis 180 degrees
Left eye distance lens Rx F=−1.00 Dₛₚₕ/−1.00 D_{cyl} axis 135 degrees
   The total vertical prismatic effect of the spherical (sph) and cylindrical (cyl) components is given again by Prentice's Rule:

Pe=dFₛₚₕ+F_{cyl}(d sin θ cos θ)

The calculations for this example are summarized in Table C below

TABLE C

| d | | | | | | | Total VPP |
|---|---|---|---|---|---|---|---|
| (cm) | Pe (RE) | Pe (LE) | ΔPe^{Δ} (RE − LE) | VPP (RE) | Therapeutic | Total VPP | (LE) |
| 2 | −14.0 | −3.0 | −11.0 | 11.0 | 10.0 | 21.0 BU | 21.0 BD |
| 1 | −7.0 | −1.5 | −5.5 | 5.5 | 10.0 | 15.5 BU | 15.5 BD |
| 0 | 0.0 | 0.0 | 0.0 | 0.0 | 10.0 | 10.0 BU | 10.0 BD |
| −1 | 7.0 | 1.5 | 5.5 | −5.5 | 10.0 | 4.5 BU | 4.5 BD |
| −2 | 14.0 | 3.0 | 11.0 | −11.0 | 10.0 | −1.0 BD | 1.0 BU |

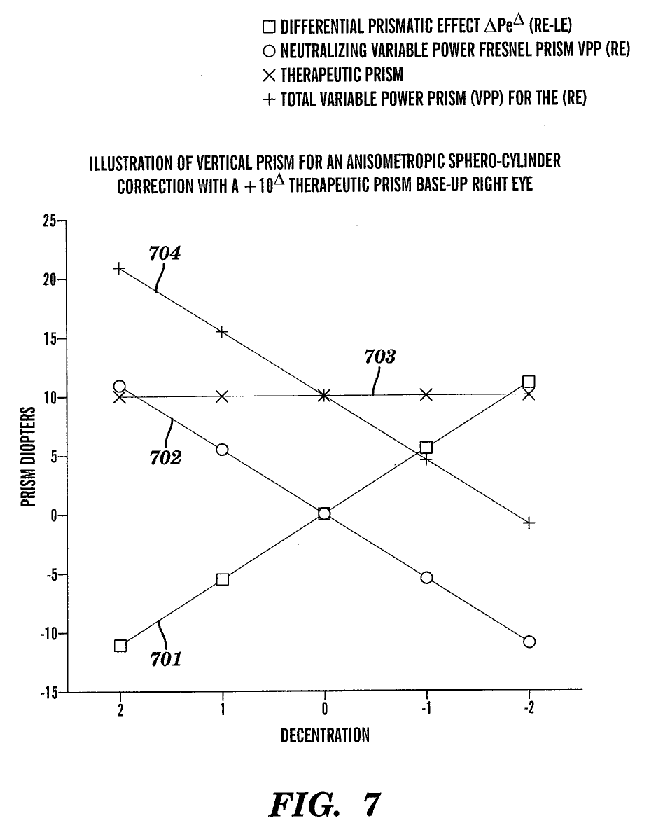

In the aspect of the invention, summarized in Table C, the vertical prismatic effects of the cylinders increase the differential prismatic effects. For example, compare ΔPe^{Δ}(RE-LE) in Example 2 with ΔPe^{Δ}(RE-LE) in this Example 3. FIG. 7 summarizes the data that appears in Table C and representative plot, similar to the plots in FIGS. 5 and 6, of the effect of one aspect of the invention. The data illustrated in FIG. 7 represent the neutralizing optical effect of an aspect of the invention when applied to a vertical prism for an anisometropic sphero-cylinder correction with a +10^{Δ} therapeutic prism base-up right eye (RE). Line 701 (identified with ▪) represents the differential prismatic effect [ΔPe^{Δ}(RE-LE)] of a prescription lens set. Line 702 (•) represents the variable power prism power according to aspects of the invention applied to the right eye (RE) that can neutralize the undesirable differential prismatic effect of the prescription lenses. Line 703 [symbol] represents the +10 D therapeutic prism, and line 704 [symbol] represents the resulting prismatic effects for both eyes by applying aspects of the invention. FIG. 7 illustrates, as indicated, the Total VPP Fresnel fitted to the right eye ranges from 21^{Δ} BU to 1^{Δ} BD (base down). According to aspects of the invention, by interchanging the base orientation, the Total VPP Fresnel can be fitted to the left eye

### Facet Construction Angles

Tables D and E below identify one typical set of refracting angles of prism facets for a variable power prism according to one aspect of the invention. Table D contains the refracting angles of facets for a variable power prism to neutralize the differential prismatic effect of a −3.00 D anisometropia, as in Example 1, for decentrations Y (YDEC)=±2.0 cm, where,

Prism aperture diameter=4.0 cm

Facet step width=0.2 cm

Substrate is PMMA with an index of refraction of 1.495.

The refracting angles listed are in degrees. Table E contains the combined refracting angles of facets for a variable power prism to neutralize the differential prismatic effect of a −3.00 D anisometropia, plus the 10 prism diopter Fresnel prism of Example 2, above, for the same given parameters listed above.

TABLE D
NEUTRALIZING PRISM
REFRACTING ANGLES
−3.00 D aniso

| YDEC | DEGREES | BASE |
|---|---|---|
| 2.0 | 6.843 | UP |
| 1.8 | 6.164 | UP |
| 1.6 | 5.484 | UP |
| 1.4 | 4.802 | UP |
| 1.2 | 4.118 | UP |
| 1.0 | 3.434 | UP |
| 0.8 | 2.748 | UP |
| 0.6 | 2.062 | UP |
| 0.4 | 1.375 | UP |
| 0.2 | 0.688 | UP |
| 0.0 | 0.000 | UP |
| −0.2 | −0.688 | DOWN |
| −0.4 | −1.375 | DOWN |
| −0.6 | −2.062 | DOWN |
| −0.8 | −2.748 | DOWN |
| −1.0 | −3.434 | DOWN |
| −1.2 | −4.118 | DOWN |
| −1.4 | −4.802 | DOWN |
| −1.6 | −5.484 | DOWN |
| −1.8 | −6.164 | DOWN |
| −2.0 | −6.843 | DOWN |

TABLE E
COMBINED PRISM
REFRACTING ANGLES
−3.00 Aniso + 10PD BU RE

| YDEC | DEGREES | BASE |
|---|---|---|
| 2.0 | 17.745 | UP |
| 1.8 | 17.119 | UP |
| 1.6 | 16.489 | UP |
| 1.4 | 15.855 | UP |
| 1.2 | 15.216 | UP |
| 1 | 14.574 | UP |
| 0.8 | 13.928 | UP |
| 0.6 | 13.279 | UP |
| 0.4 | 12.626 | UP |
| 0.2 | 11.969 | UP |
| 0 | 11.310 | UP |
| −0.2 | 10.647 | UP |
| −0.4 | 9.982 | UP |
| −0.6 | 9.314 | UP |
| −0.8 | 8.643 | UP |
| −1.0 | 7.970 | UP |
| −1.2 | 7.294 | UP |
| −1.4 | 6.617 | UP |
| −1.6 | 5.937 | UP |
| −1.8 | 5.256 | UP |
| −2 | 4.574 | UP |

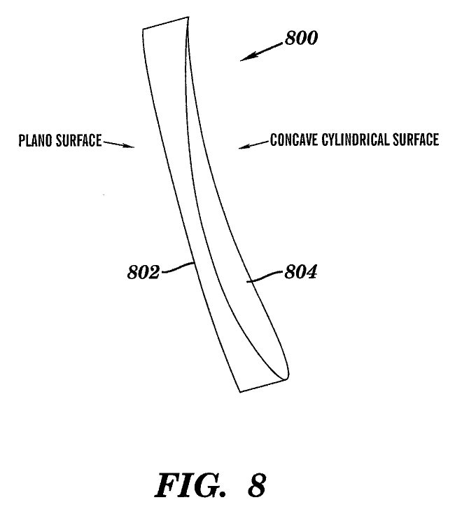

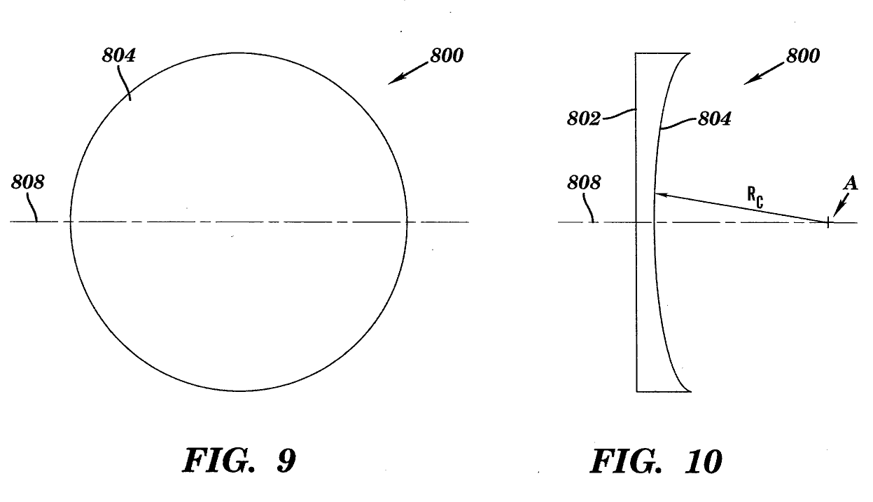

FIG. 8 is a perspective view of an optic 800 according to another aspect of the invention. FIG. 9 is a front elevation view of optic 800 shown in FIG. 8. FIG. 10 is a side elevation view of the optic 800 shown in FIG. 8. Where the optics in FIGS. 1-7 are illustrated as two-dimensional views, it will be understood by those of skill in the art, that according to aspects of the invention the optics, for example, optics 80 and 100, may typically be circular in shape, for example, to mimic the circular shape of the lenses for which aspects of the invention may be used. FIG. 8 shows one aspect of the invention where optic 800 is generally circular in shape, as shown in FIG. 9. Optic 800 comprises a first surface 802 and a second surface 804. (Though in some aspects of the invention, optic 800 may include discontinuous, faceted surfaces and/or edges, in the aspect of the invention shown in FIG. 8, the appearance discontinuous surfaces and edges is a remnant of the wire frame provided by the drafting program. In a preferred aspect of the invention, optic 8 includes smooth and continuous surfaces, that is, not having facets.)

According to aspects of the invention, surfaces 802 and 804 may have a broad range of topologies or profiles, for example, surfaces 802 and 804 may be planar, cylindrical, aspherical, conic, elliptical, parabolic, hyperbolic, or toroidal, among other topologies. According to aspects of the invention optic 800 has a profile as viewed from the side as in FIG. 10. For example, FIG. 10 illustrates a radiused or circular profile. According to aspects of the invention, optic 800 may have a broad range of profiles, including radiused, circular, acircular, elliptical, parabolic, and hyperbolic profiles, among others. In the aspect of the invention shown in FIGS. 8 to 10, surface 802 of optic 800 is a generally planar surface and surface 804 is a generally cylindrical surface, for example, having a cylindrical radius R_{C}. In one aspect, surface 802 or surface 804 may have a spherical radius, R_{S} (not shown). According to one aspect of the invention, the desired variation in prismatic power may vary in any direction, for example, vertically, horizontally, radially, meridianally, or at some oblique angle to the optical axis 808a/b. For example, as shown in FIGS. 8-10, the axis A of the cylindrical surface 804 is horizontal, and the curvature R_{C} is vertical. Accordingly, in this aspect, the curvature of surface 804 deviates the path of light rays vertically

As shown most clearly in FIG. 9, the variation in the prism geometry may cause reflection and scattering and may generally degrade the optical resolution. The smooth and continuous geometry of surfaces 802 and/or 804 will more smoothly deviate light rays, for example, in a continuum. In one aspect, generating a smooth cylindrical curvature is preferred to providing a plurality of closely spaced planar prism facets. In one aspect, a substantially continuous cylindrical surface is provided. Aspects of the invention, either discontinuous facets or substantially continuous facets or surfaces, can correct prismatic imbalance caused by differential prismatic effects that are deleterious to normal single binocular vision.

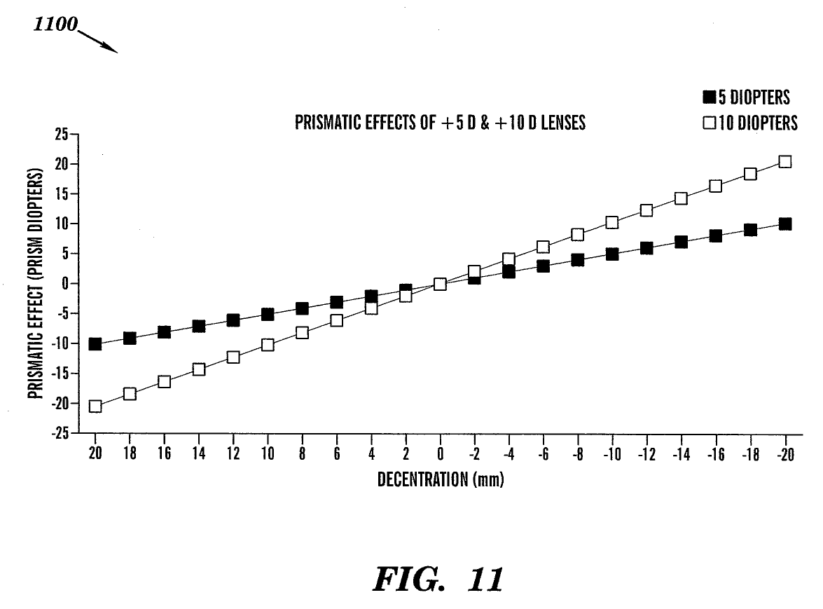

FIG. 11 is a set of curves 1100 illustrating the prismatic effect of one aspect of the invention. The data illustrated by curves 1100 are for a right eye having +5 D lens and a left eye having +10 D lens plotted for decentration of +/−20 mm. The data for curves 1100 are tabulated in Table F. For example, as shown in Table F (and in FIG. 11), for a decentration of 20 mm, the prismatic effects of the two lenses are 10.2 and 20.6 diopters, respectively. The differential prismatic effect (or imbalance) shown in column D of Table F is 10.4 prism diopters. A cylindrical corrector lens, according to aspects of the invention, with a curvature of 0.01 placed in front of the +10 D left lens reduces the differential prismatic effect of the +10 D lens to 10.4 prism diopters, thus reducing the differential prismatic effect to 0.3 prism diopters. In this case, assuming the cylindrical curvature is along the vertical meridian, the light ray deviations will be vertical.

TABLE F
Prismatic and Differential Prismatic effects of a +5 D Right eye
and a +10 D Lens decentered +/−20 mm.

| | | | | D | E |
|---|---|---|---|---|---|
| | A | B | C | B − A | C − A |
| DEC | 5 DIOPTERS | 10 DIOPTERS | CVX | PSM | PSM |
| mm Y | PSM DPT | PSM DPT | PSM DPT | DPT | DPT |
| 20 | −10.2 | −20.6 | −10.5 | −10.4 | −0.3 |
| 18 | −9.1 | −18.4 | −9.4 | −9.3 | −0.3 |
| 16 | −8.1 | −16.3 | −8.4 | −8.2 | −0.3 |
| 14 | −7.1 | −14.2 | −7.3 | −7.1 | −0.3 |
| 12 | −6.0 | −12.2 | −6.3 | −6.1 | −0.2 |
| 10 | −5.0 | −10.1 | −5.2 | −5.0 | −0.2 |
| 8 | −4.0 | −8.0 | −4.2 | −4.0 | −0.2 |
| 6 | −3.0 | −6.0 | −3.1 | −3.0 | −0.1 |
| 4 | −2.0 | −4.0 | −2.1 | −2.0 | −0.1 |
| 2 | −1.0 | −2.0 | −1.0 | −1.0 | −0.0 |
| 0.0 | 0.0 | 0.0 | 0.0 | 0.0 | 0.0 |
| −2 | 1.0 | 2.0 | 1.0 | 1.0 | 0.0 |
| −4 | 2.0 | 4.0 | 2.1 | 2.0 | 0.1 |
| −6 | 3.0 | 6.0 | 3.1 | 3.0 | 0.1 |
| −8 | 4.0 | 8.0 | 4.2 | 4.0 | 0.2 |
| −10 | 5.0 | 10.1 | 5.2 | 5.0 | 0.2 |
| −12 | 6.0 | 12.2 | 6.3 | 6.1 | 0.2 |
| −14 | 7.1 | 14.2 | 7.3 | 7.1 | 0.3 |
| −16 | 8.1 | 16.3 | 8.4 | 8.2 | 0.3 |
| −18 | 9.1 | 18.4 | 9.4 | 9.3 | 0.3 |
| −20 | 10.2 | 20.6 | 10.5 | 10.4 | 0.3 |

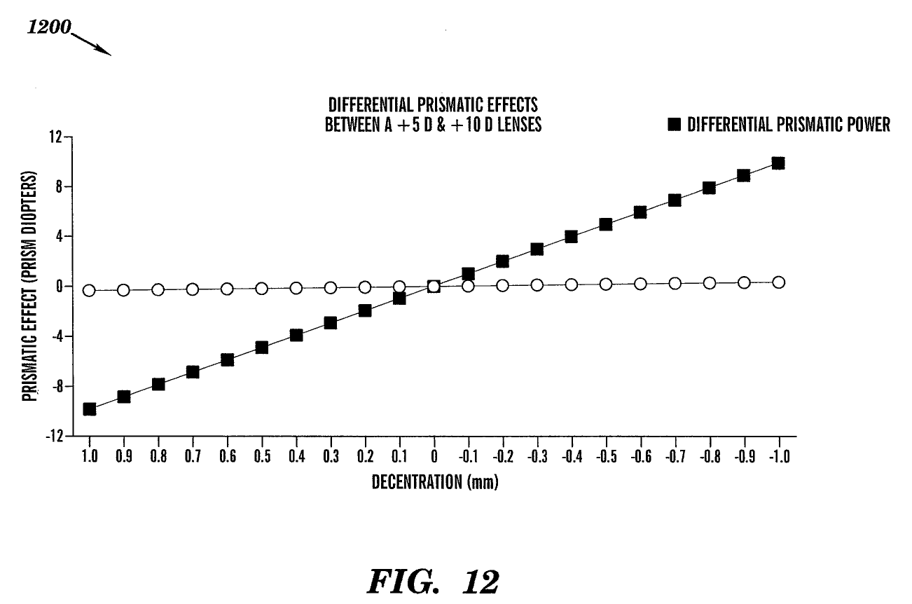

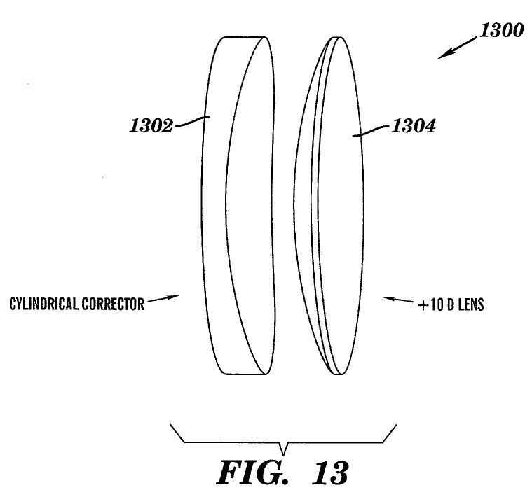

FIG. 12 is a set of curves 1200 illustrating the prismatic effect of one aspect of the invention. The black squares in FIG. 12 illustrate the differential prismatic effect that produces vertical prism imbalances for the two eyes in the above example. A concave cylindrical correction lens or optic, according to aspects of the invention, with a circular curvature of 0.01 placed in from the of the +10 D left eye lens may almost completely eliminate the vertical imbalance, as indicated by the grey circles in FIG. 12. In one aspect of the invention, even better correction may be obtained by using a conic curvature or profile, for example, an elliptical, parabolic, or hyperbolic curvature or profile.

FIG. 13 is a perspective view of an arrangement 1300 of a prism optic and a lens according to an aspect of the invention. In FIG. 13, a prismatic optic 1302 is positioned before a corrective lens 1304 to provide the desired correction. (Again, the wire frames shown in FIG. 13 are a remnant of the drafting program. Though in some aspects of the invention the optic 1302 may be faceted, in a preferred aspect, optic 1302 comprises smooth surfaces.) In this case, corrective lens is a +10 D lens, as in the example above, and the prismatic optic 1302 has one planar surface and one cylindrical surface. Though aspects of the invention may be provided as individual optics distinct from the corrective lens, as shown in FIG. 13, according to other aspects of the invention, the corrective prismatic optics may be integrated into the corrective lens, for example, positioned on one or both surfaces of the corrective lens or integrated into the geometry of the corrective lens.

Aspects of the present invention may be fabricated by any conventional prism manufacturing process. For example, variable power prisms according to aspects of the invention may be made by injection molding, for example, by impressing the facets by injection molding of glass or plastic onto an optical plastic or glass substrate.

It will be clear to those of skill in the art that aspects of the invention provide optical devices that overcome the limitations of the prior art devices. For examples, aspects of the present invention can equalize differential prismatic effects of right and left eye lenses over their entire aperture in aniso- and anti-metropia. In addition, aspects of the invention can provide constant prescribed therapeutic prism power across the lens aperture by offsetting the prismatic effect of a lens in the absence of anisometropia. Moreover, aspects of the invention can provide a variation in prism power for vision training in strabismus, head trauma, etc. conditions.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. An optical element comprising a plurality of integral prism facets having varying prismatic power.

2. The optical element as recited in claim 1, wherein the plurality of facets comprise a first plurality of facets having a base-down prismatic power and a second plurality of facets having a base-up prismatic power.

3. The optical element as recited in claim 2, wherein the first plurality of prism facets is positioned above an optical center of the element and the second plurality of prism facets is positioned below the optical center of the element.

4. The optical element as recited in claim 2, wherein the first plurality of prism facets is positioned below an optical center of the element and the second plurality of prism facets is positioned above the optical center of the element.

5. The optical element as recited in claim 2, wherein an absolute value of the prismatic power of the first plurality of prism facets and the second plurality of prism facets increases with a distance from an optical center of the device.

6. The optical element as recited in claim 1, wherein the optical element further comprises a third plurality of prism facets having a substantially constant prismatic power.

7. The optical element as recited in claim 6, wherein the third plurality of prism facets are positioned to refract at least some light rays before the light rays enter the plurality of integral prism facets.

8. The optical element as recited in claim 1, wherein the plurality of integral prism facets is applied to a substrate.

9. The optical element as recited in claim 1, wherein the plurality of integral prism facets comprise a plurality of glass or plastic prism facets.

10. The optical element as recited in claim 1, wherein optical element has a thickness between about 1 and about 5 mm.

11. An optical arrangement comprising:
a lens having a prismatic effect upon light rays passing through the lens; and
the optical element as recited in claim 1;
wherein the varying prismatic effect of the optical element modifies at least some of the prismatic effect of the lens on the light rays.

12. The optical arrangement as recited in claim 11, wherein the prismatic effect of the lens comprises a prismatic effect that varies across the lens.

13. The optical arrangement as recited in claim 11, wherein the lens comprises one of a positive lens and a negative lens.

14. The optical arrangement as recited in claim 11, wherein the lens comprises one of a spherical, an aspherical, and a sphero-cylindrical lens.

15. The optical arrangement as recited in claim 11, wherein the arrangement is adapted to mount as eye wear.

16. A method of correcting binocular vision comprising
providing a right lens and a left lens having differential prismatic effect upon light rays passing through the lenses; and
positioning the optical element recited in claim 1 to modify at least some of the differential prismatic effect of the lenses.

17. The method as recited in claim 16, wherein providing the lenses comprises providing at least one of a positive lens and a negative lens.

18. An optical element comprising a substantially continuous, smooth surface providing varying prismatic power.

19. The optical element as recited in claim 18, wherein the substantially continuous, smooth surface comprises one of a circular profile and a non-circular profile.

20. The optical element as recited in claim 18, wherein the optical element further comprises a substantially planar surface opposite the continuous, smooth surface.
